(19) United States
(12) Patent Application Publication
(10) Pub. No.: US 2011/0148181 A1
(43) Pub. Date: Jun. 23, 2011

(54) WHEEL CLADDING AND SYSTEM

(76) Inventors: Marcelo Silva de Carvalho, Limeira SP (BR); Flavio Rodrigues, Limeira SP (BR)

(21) Appl. No.: 12/921,334

(22) PCT Filed: Mar. 6, 2008
(86) PCT No.: PCT/BR2008/000063

§ 371 Date: Nov. 29, 2010

(51) Int. Cl. B60B 7/06; B60B 7/02

(52) U.S. Cl. 301/37.102; 301/37.101; 301/37.42

(57) ABSTRACT

A wheel cladding system (18) includes a wheel (10) having a wheel rim (14) and a wheel disk (16) attached to the wheel rim (14). The wheel disk (16) includes a peripheral flange (18) extending circumferentially about a central section (20) having radially extending disk spokes (22). The peripheral flange (18) includes a slot (24). A wheel cladding (12) is secured to the wheel (10) and includes an inner side (36) and an outer side (38) relative to the wheel disk (16). The wheel cladding (12) includes a peripheral edge (40) extending about a central wheel cladding section (42) having wheel cladding spokes (44). The peripheral edge (40) is engaged with the slot (24) and the wheel cladding spokes (44) are engaged with the disk spokes (12) to secure the wheel cladding (12) on the wheel (10).

### BACKGROUND OF THE INVENTION

This disclosure relates to wheel claddings and, more particularly, to a wheel cladding and system that provide an attractive appearance, relatively simple assembly, and relatively economic manufacturing.

Automobiles and other types of vehicles typically include wheels having a wheel rim and a wheel disk that are secured together. For example, the wheel rim and the wheel disk may be stamped from an alloy such as carbon steel and then welded together. In general, stamped wheels provide economic manufacturing, satisfactory performance, and are relatively easy to repair. However, one drawback of stamped wheels is that the wheel may have a relatively unattractive visual appearance.

Wheel covers have been used to conceal the appearance of visually unattractive wheels. However, conventional wheel covers have the drawback that the wheel covers may become easily damaged from exposure to the surrounding environment, which may detract from the appearance.

### SUMMARY OF THE INVENTION

The wheel cladding and system disclosed herein are intended to be durable and provide relatively easy attachment to a wheel.

In disclosed examples, a wheel cladding system includes a wheel having a wheel rim and a wheel disk attached to the wheel rim. The wheel disk includes a peripheral flange extending circumferentially about a central section having radially extending disk spokes. The peripheral flange includes a slot. A wheel cladding is secured to the wheel and includes an inner side and an outer side relative to the wheel disk. The wheel cladding includes a peripheral edge extending about a central wheel cladding section having wheel cladding spokes. The peripheral edge is engaged with the slot and the wheel cladding spokes are engaged with the disk spokes in the vent holes areas to provide an interference fit between the wheel cladding and the wheel.

In another aspect, a wheel cladding includes a light-transmitting plastic skin having an inner side for facing the wheel and an outer side for facing away from the wheel. A coating is disposed on the inner side of the light-transmitting plastic skin to provide a desirable visual appearance through the light-transmitting plastic skin.

In another aspect, a wheel cladding system includes the wheel cladding having the light-transmitting plastic skin and coating secured on a wheel having a wheel rim and a wheel disk that is attached to the wheel rim.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an exploded view of a wheel system having a wheel and a wheel cladding.

FIG. 2 illustrates a cross-sectional view of the wheel cladding attached on the wheel.

FIG. 3 illustrates the wheel with elastomer members.

FIG. 4 illustrates the wheel with elastomer members in different locations.

FIG. 5 illustrates a portion of another embodiment wheel cladding and system.

FIG. 6 illustrates a portion of another embodiment wheel cladding and system.

FIG. 7 illustrates a portion of another embodiment wheel cladding and system.

FIG. 8 illustrates a portion of another embodiment wheel cladding and system.

FIG. 9 illustrates a cross-section of the wheel cladding and system of FIG. 8.

FIG. 10 illustrates another embodiment wheel cladding having a light-transmitting plastic skin and a coating.

FIG. 11 illustrates a work piece used to fabricate a wheel cladding having a light-transmitting plastic skin.

FIG. 12 illustrates the work piece with a coating deposited on the inner side of a light-transmitting plastic skin.

### DETAILED DESCRIPTION OF THE PREFERRED EMBODIMENT

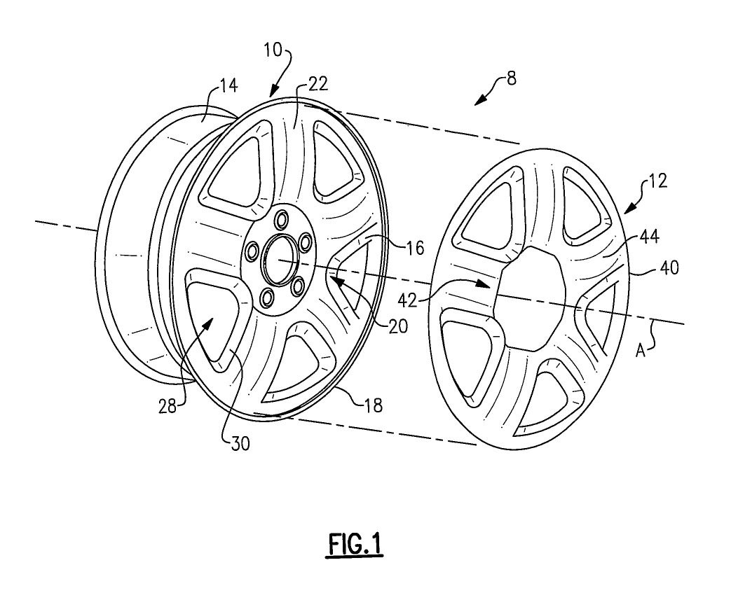

FIG. 1 illustrates selected portions of an exploded view of a wheel cladding and system 8 having a wheel 10 and wheel cladding 12 that is securable onto the wheel 10. This disclosure generically uses the term “cladding” to refer to an element that at least partially covers the wheel 10, and the term “cladding” is not necessarily intended to incorporate any specific structure or material. Thus, the wheel cladding 12 may include a single layer of material, multiple layers of like or dissimilar materials, or be formed from plastic, metal, or composite materials.

The wheel 10 is generally rotatable about axis A when used on a vehicle. It is to be understood that any reference herein to “axial”, “radial”, or variations thereof is relative to the axis A. As will be described, the wheel 10 and wheel cladding 12 provide a relatively simple assembly that is durable and that may be economically manufactured. The particular design of the wheel 10 and wheel cladding 12 of the disclosed examples may vary depending on the intended end use. In the illustrated examples, the wheel 10 includes a rim 14 and a disk 16 that is attached to the rim 14. For instance, the disk 16 and rim 14 are welded together.

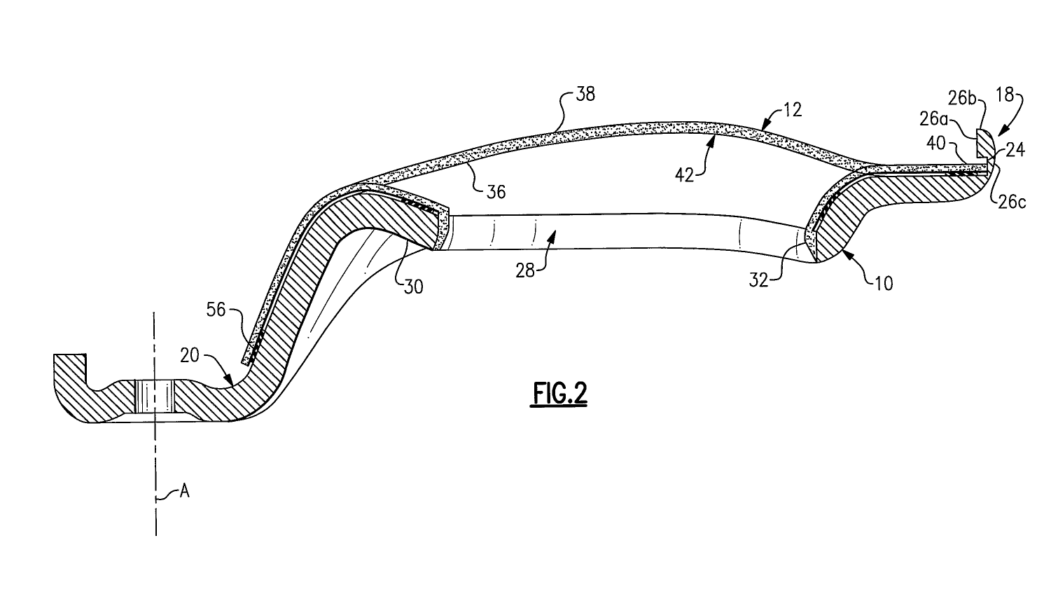

FIG. 2 illustrates a cross-sectional view of the wheel cladding 12 secured on the wheel 10. The disk 16 includes a peripheral flange 18 that extends circumferentially about a central section 20 having a plurality of radially extending disk spokes 22. The peripheral flange 18 generally extends in an axial direction relative to the axis A of the wheel 10 and includes a slot 24 that extends entirely circumferentially around the peripheral flange 18. The peripheral flange 18 includes a radially inner face 26a, an axial face 26b, and a radially outer face 26c. In this example, the slot 24 is recessed within the radially inner face 26a of the peripheral flange 18 and generally opens radially inwards. The disk spokes 22 also define wheel vents holes 28, which may also be referred to as vent openings or vent opening areas. In this example, each of the disk spokes 22 includes flange 30 that extends around the vent holes 28.

The wheel cladding 12 is generally contoured to fit intimately with the wheel 10 and includes an inner side 36 and an outer side 38 relative to the disk 16. A peripheral edge 40 of the wheel cladding 12 extends about a central wheel cladding section 42 that includes wheel cladding spokes 44.

In the illustrated example, the wheel cladding spokes 44 are designed with a shape that facilitates engagement with the flanges 30 of the disk spokes 22. For instance, each of the wheel cladding spokes 44 includes a flange 32 that extends axially into the vents holes 28 between the disk spokes 22 and provides interference with the flanges 30 of the disk spokes 22 to limit movement. Additionally, the peripheral edge 40 of the wheel cladding 12 is in engagement with the slot 24 of the peripheral flange 18. The engagement with the slot 24 and the disk spokes 22 provides an interference fit that secures the wheel cladding 12 and the wheel 10 together. For example, the engagement between the slot 24 and the peripheral flange 18 limits axial movement of the wheel cladding 12, while engagement between the flanges 32 of the wheel cladding spokes 44 and the flanges 30 of the disk spokes 22 limits radial movement of the wheel cladding 12.

The wheel cladding 12 may be fabricated from a metal alloy, composite, or plastic material to facilitate assembly onto the wheel 10. For instance, the selected material may have a degree of flexibility that allows the wheel cladding to be non-permanently deformed for engagement with the slot 24. Additionally, the flexibility allows the flanges 32 of the wheel cladding spokes 44 to resiliently spread apart as the wheel cladding 12 is engaged onto the disk spokes 22. Attaching the wheel cladding 12 to the wheel 10 using the slot 24 and resiliency of the flanges 32 provides a relatively simple and reliable fixation. Additionally, using the slot 24 and flexible wheel cladding spokes 44 to secure the wheel cladding 12 and wheel 10 together allows another wheel cladding 12 (perhaps of a different style) to be secured over the wheel cladding 12 that has already been attached to the wheel 10.

Optionally, one or more elastomer members 56 may be located between the wheel cladding 12 and the disk 16. For example, the elastomer members 56 facilitate reduction of noise due to vibration of the wheel cladding 12 relative to the wheel 10 and seal the interface between the wheel cladding 12 and the disk 16 from the surrounding environment (e.g., moisture). The elastomer members 56 may be fabricated from any type of elastomer material that is suitable for vibration damping. For example, the elastomer members 56 may be silicone. As can be appreciated, the location of the elastomer members 56 relative to the wheel cladding 12 and the disk 16 may vary depending upon the design of the wheel cladding 12 and the disk 16.

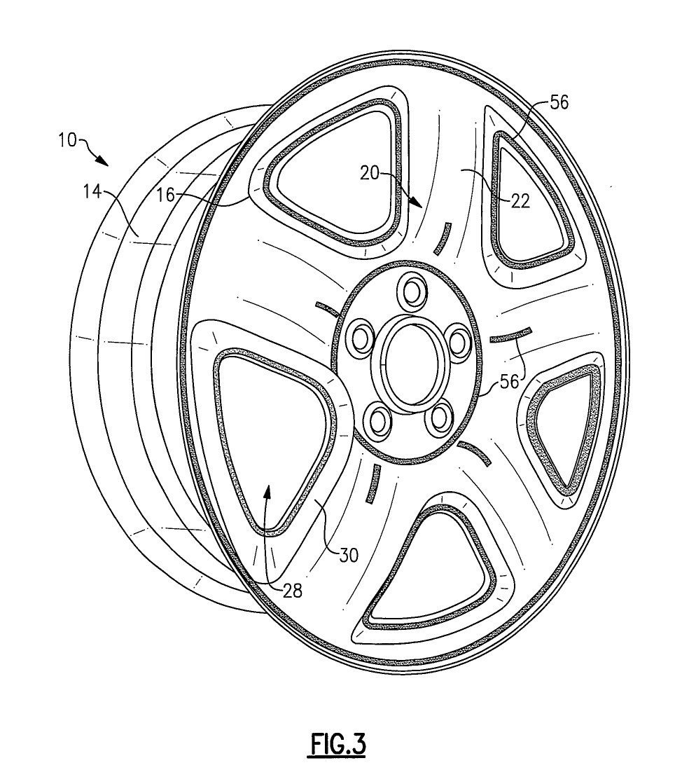

Referring to FIGS. 3 and 4, the elastomer members 56 may generally be located adjacent to the disk spokes 22 and at various locations over the central section 20. In FIG. 3, the elastomer members 56 on the disk spokes 22 are oriented radially. In FIG. 4, the elastomer members 56 on the disk spokes 22 are oriented circumferentially.

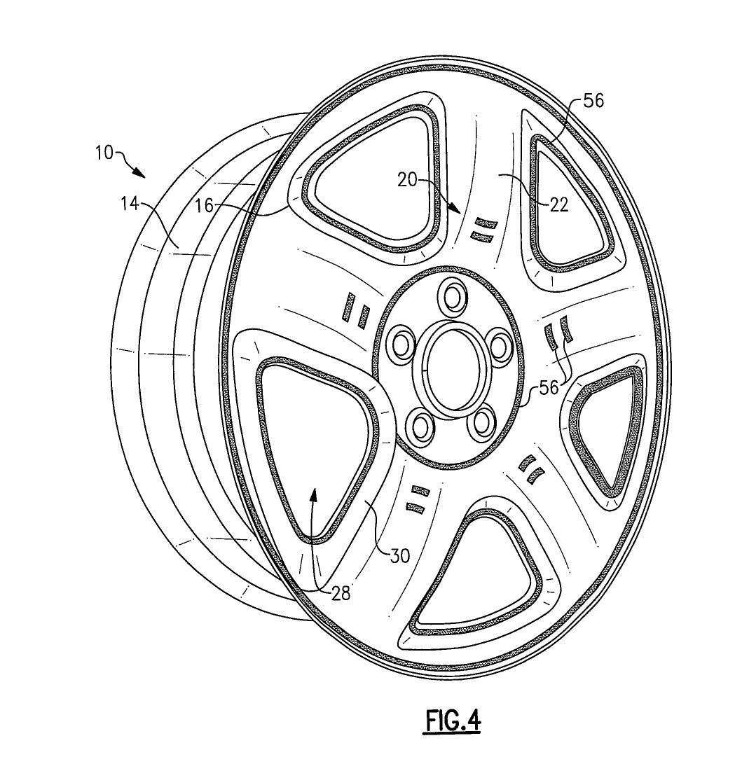

FIG. 5 illustrates a portion of another embodiment wheel cladding and system 108. In this disclosure, like reference numerals designate like elements where appropriate. Reference numerals that include the addition of one-hundred or multiples thereof, a letter, or a prime symbol may designate modified elements. The modified elements incorporate the same features and benefits of the corresponding modified elements, expect where stated otherwise.

In this example, the peripheral edge 140 of the wheel cladding 112 includes a cladding flange 141. The cladding flange 141 extends to the left FIG. 5 and then loops around approximately 180° to the right to form a retrograde portion 143. The slot 124 of the peripheral flange 118 of the disk 116 is recessed within the axial face 126b. The cladding flange 141 engages the slot 124 to secure the wheel cladding 112 and the wheel 110 together. In some examples, the cladding flange 141 may be mechanically deformed around the peripheral flange 118 and into the slot 124.

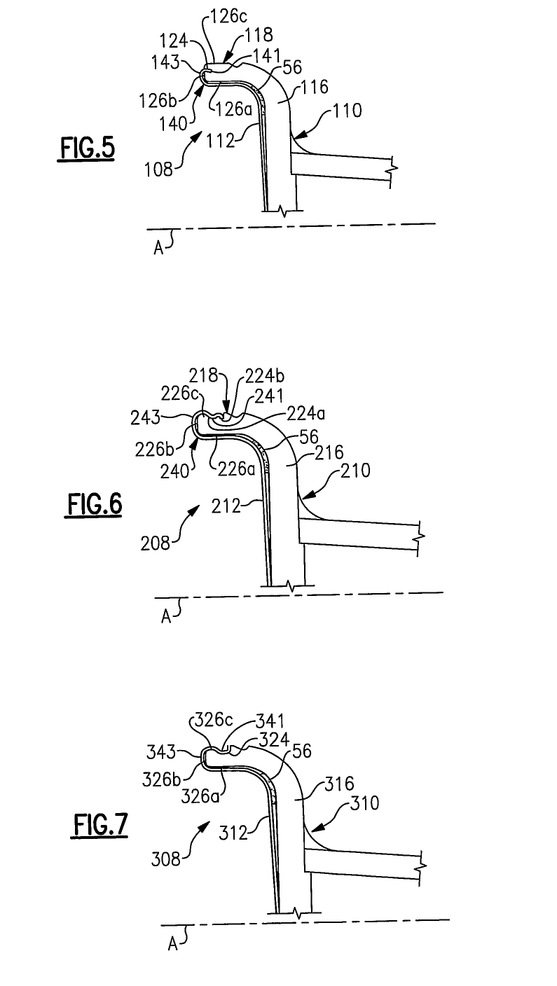

FIG. 6 illustrates a portion of another embodiment wheel cladding and system 208. In this example, the peripheral edge 240 of the wheel cladding 212 includes a cladding flange 241. The cladding flange 241 extends to the left in FIG. 6 and then loops around approximately 180° to the right to form a retrograde portion 243. The peripheral flange 218 of the disk 216 includes slots 224a and 224b that are recessed within the radially outer face 126c. The cladding flange 241 engages the slots 224a and 224b to secure the wheel cladding 212 and the wheel 210 together. In some examples, the cladding flange 241 may be mechanically deformed around the peripheral flange 218 and into the slot 224.

FIG. 7 illustrates a portion of another embodiment wheel cladding and system 308. In this example, the peripheral edge 340 of the wheel cladding 312 includes a cladding flange 341. The cladding flange 341 extends to the left FIG. 7 and then loops around approximately 180° to the right to form a retrograde portion 343. The slot 324 of the peripheral flange 318 of the disk 316 is recessed within the radially outer face 326c. The cladding flange 341 engages the slot 324 to secure the wheel cladding 312 and the wheel 310 together. In some examples, the cladding flange 341 may be mechanically deformed around the peripheral flange 318 and into the slot 324.

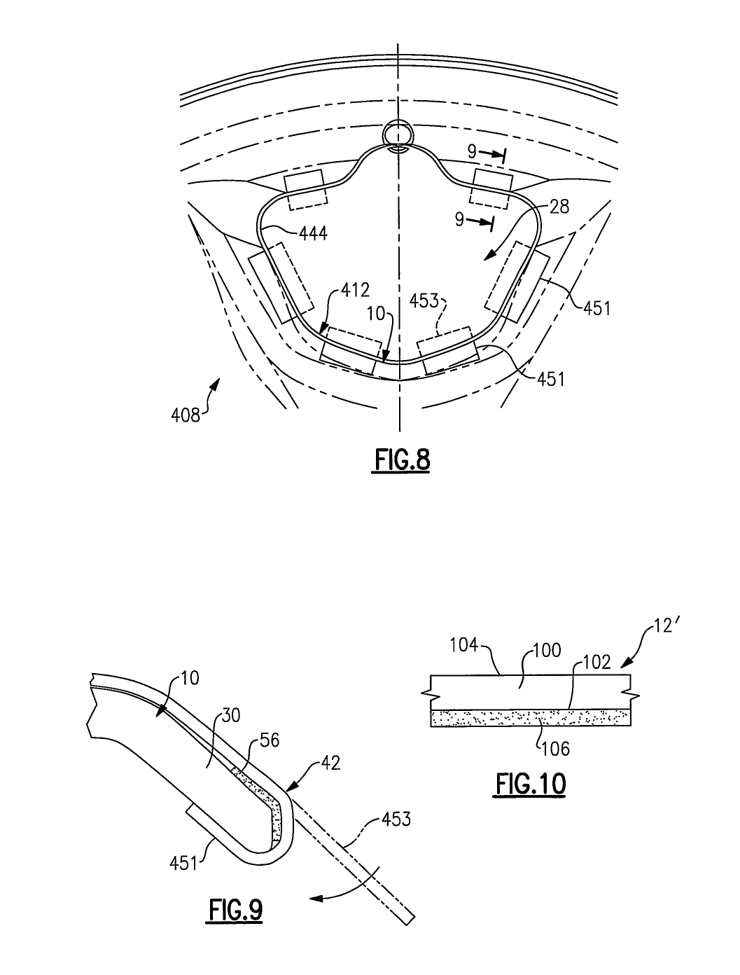

FIGS. 8 and 9 illustrate portions of another embodiment wheel system 408. In this example, the wheel cladding 412 is shown superimposed on the wheel 10 to demonstrate the fixation between the wheel cladding 412 and the wheel 10. The wheel cladding 412 include tabs 451 spaced around the periphery of the vent holes 28. The tabs 451 are bendable into the illustrated engaged position from a non-engaged position represented by dashed lines 453. In some examples, the tabs are initially in the non-engaged position 453 and are then mechanically deformed to conform with the flanges 30 of the disk spokes 22 to lock the wheel cladding 412 and the wheel 10 together. As can be appreciated, the tabs 451 may be used as a sole fixation system or in combination with any of the disclosed peripheral edges 40, 140, 240, or 340.

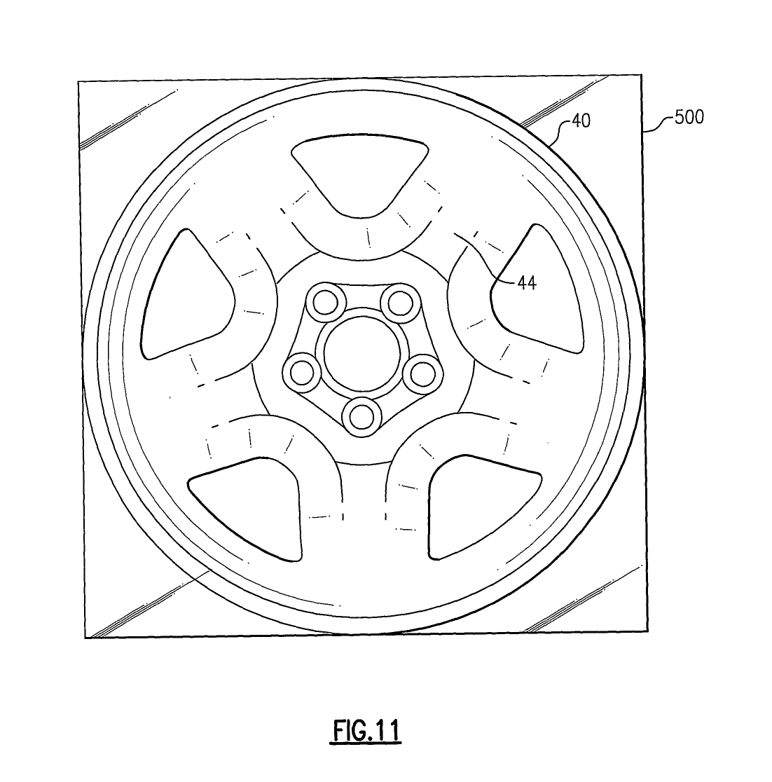

FIG. 10 illustrates a cross-section of a portion of another example of a wheel cladding 12′ that is similar to the wheel cladding 12 and may be secured to the wheel 10 in the same manner as the wheel cladding 12. In this example, the wheel cladding 12′ includes a light-transmitting plastic skin 100 having an inner side 102 for facing toward the wheel 10 and an outer side 104 for facing away from the wheel 10. A coating 106 is disposed on the inner side 102. The light-transmitting plastic skin 100 and coating 106 provide a desired visual appearance. For instance, the light-transmitting nature of the light-transmitting skin 100 allows an observer viewing the wheel cladding 12′ to see visual effects from the coating 106.

The light-transmitting plastic skin 100 may be any type of plastic that is capable of transmitting at least some light. For instance, the plastic may be translucent or transparent. In some examples, the light-transmitting plastic skin 100 is polycarbonate, acrylonitrile-butadiene styrene, or polymethyl methacrylate. The selection of the type of plastic may depend on the needs of a given application, such as thermal resistance. For example, polycarbonate may exhibit a desirable thermal resistance to heat generated from wheel rotation or other factors. Given this description, one of ordinary skill in the art will recognize other types of plastic materials to suit their particular needs.

The coating 106 may be any type of coating for providing a desired visual appearance. For instance, the coating 106 may be a metallic coating, such as a chromate coating, to provide a metallic appearance. As can be appreciated, other types of metals or coatings may also be used. Alternatively, the coating 106 may be a paint having a desired color or attractive visual appearance. Given this description, one of ordinary skill in the art will recognize other types of the coating 106 to suit their particular needs.

The wheel cladding 12′ is relatively durable and resistant to damage that may otherwise mar the appearance of prior wheel claddings. For instance, since the coating 106 is disposed on the inner side 102 of the light-transmitting plastic skin 100 rather than on the outer side 104, the coating 106 is not easily susceptible to damage from the surrounding environment, such as from the impact of debris. Because the light-transmitting plastic skin 100 is clear or translucent, any damage to the light-transmitting plastic skin 100 may be relatively imperceptible.

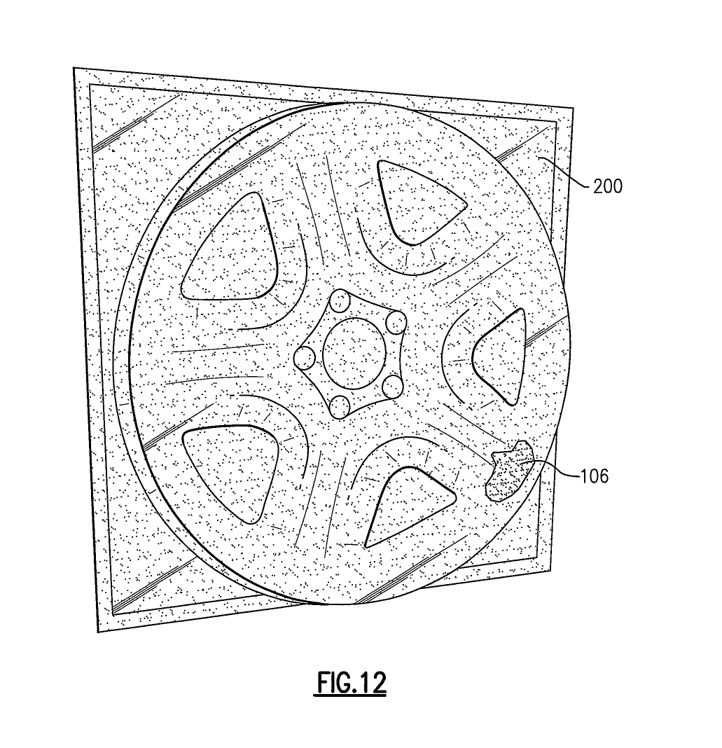

The wheel claddings 12 and 12′ described herein also provide relatively economic manufacturing. For instance, the wheel cladding 12 or 12′ may be formed from a generally flat sheet of plastic material in a vacuum molding process, or injection molded using known techniques. Referring to FIGS. 11 and 12, vacuum molding, injection molding, or other type of forming process may be used to form a plastic work piece 500 with contours corresponding to the wheel 10. After forming the work piece 500, vents between the wheel cladding spokes 44 and excess material around the peripheral edge 40 may be cut away, leaving the wheel cladding 12 or 12′.

For the wheel cladding 12′, the coating 106 may be applied to the inner side 102 of the work piece 500 (FIG. 12) before cutting away the vents and excess material. For example, the coating 106 may be painted, sprayed, or deposited onto the inner side 102 using any suitable known technique.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

1. A wheel cladding system comprising:
a wheel including a wheel rim and a wheel disk attached to the wheel rim, the wheel disk including a peripheral flange extending circumferentially about a central section having radially extending disk spokes, the peripheral flange including a slot; and
a wheel cladding having an inner side and an outer side relative to the wheel disk, the wheel cladding including a peripheral edge extending about a central wheel cladding section having wheel cladding spokes, wherein the peripheral edge is engaged with the slot and the wheel cladding spokes are engaged with the radially extending disk spokes to provide an interference fit between the wheel cladding and the wheel.

2. The wheel cladding system as recited in claim 1, wherein the slot extends entirely circumferentially around the peripheral flange.

3. The wheel cladding system as recited in claim 1, wherein the radially extending disk spokes each include a flange engaged with corresponding flanges of the wheel cladding spokes.

4. The wheel cladding system as recited in claim 1, wherein the wheel cladding spokes are flexible.

5. The wheel cladding system as recited in claim 1, further including at least one elastomer member located between the wheel cladding and the wheel disk.

6. The wheel cladding system as recited in claim 1, wherein the slot opens to an axial face of the peripheral flange.

7. The wheel cladding system as recited in claim 1, wherein the slot opens to a radial face of the peripheral flange.

8. The wheel cladding system as recited in claim 1, wherein the peripheral edge of the wheel cladding includes a cladding flange that extends in an axial direction.

9. The wheel cladding system as recited in claim 8, wherein the cladding flange is a retrograde portion.

10. The wheel cladding system as recited in claim 1, wherein the wheel cladding spokes include tabs that are bendable between a non-engaged position and an engaged position with respect to the radially extending disk spokes.

11. The wheel cladding system as recited in claim 10, wherein the wheel cladding spokes define wheel cladding vent holes there between, and the tabs are spaced around a periphery of the wheel cladding vent holes.

12. A wheel cladding comprising:
a light-transmitting plastic skin having a inner side for facing a wheel and an outer side for facing away from the wheel; and
a coating disposed on the inner side.

13. The wheel cladding as recited in claim 12, wherein the light-transmitting plastic skin is transparent.

14. The wheel cladding as recited in claim 12, wherein the light-transmitting plastic skin includes at least one of polycarbonate, acrylonitrile-butadiene styrene, or polymethyl methacrylate.

15. The wheel cladding as recited in claim 12, wherein the coating is a metallic coating.

16. The wheel cladding as recited in claim 12, wherein the coating is paint.

17. The wheel cladding as recited in claim 12, wherein the light-transmitting plastic skin includes a peripheral edge extending about a central wheel cladding section having wheel cladding spokes that are flexible.

18. A wheel cladding system comprising:
a wheel including a wheel rim and a wheel disk attached to the wheel rim; and
a wheel cladding that is securable to the wheel, the wheel cladding including a light-transmitting plastic skin having a inner side facing the wheel disk and an outer side facing away from the wheel disk, and a coating disposed on the inner side.

19. The wheel cladding system as recited in claim 18, wherein the light-transmitting plastic skin is transparent.

20. The wheel cladding system as recited in claim 18, wherein the light-transmitting plastic skin includes at least one of polycarbonate, acrylonitrile-butadiene styrene, or polymethyl methacrylate.

21. The wheel cladding system as recited in claim 18, wherein the coating is a metallic coating.

22. The wheel cladding system as recited in claim 18, wherein the wheel disk includes a peripheral flange extending circumferentially about a central section having radially extending disk spokes, and the peripheral flange includes a slot.

23. The wheel cladding system as recited in claim 22, wherein the wheel cladding includes a peripheral edge extending about a central wheel cladding section having wheel cladding spokes, and the peripheral edge is engaged with the slot and the wheel cladding spokes are engaged with the radially extending disk spokes to secure the wheel cladding on the wheel.

24. The wheel cladding system as recited in claim 18, wherein the wheel cladding includes a peripheral edge extending about a central wheel cladding section having wheel cladding spokes that are flexible.
